(19) United States
(12) Patent Application Publication
(10) Pub. No.: US 2025/0053868 A1
(43) Pub. Date: Feb. 13, 2025

(54) METHOD AND ELECTRONIC DEVICE FOR OPTIMIZING TRAINING OF DATA DRIVEN MODEL IN WIRELESS NETWORK

(71) Applicant: Samsung Electronics Co., Ltd., Suwon-si (KR)

(72) Inventors: Sandeep Kumar JAISAWAL, Bangalore (IN); Sukhdeep SINGH, Bangalore (IN); Joseph THALIATH, Bangalore (IN); Seungil YOON, Suwon-si (KR); Peter Moonki HONG, Suwon-si (KR)

(21) Appl. No.: 18/752,263

(22) Filed: Jun. 24, 2024

(30) Foreign Application Priority Data
Aug. 7, 2023 (IN) 202341053015

(51) Int. Cl. G06N 20/00

(52) U.S. Cl. CPC G06N 20/00

(57) ABSTRACT

Methods for optimizing training of a data driven model in a wireless network by data driven model validation controller running in electronic device. The method may include obtaining and selecting a candidate data driven model from a plurality of candidate data driven models. The method may include determining whether the selected candidate data driven model meets a predefined prediction. The method may include deploying the selected candidate data driven model to a target deployment environment upon determining that the selected candidate data driven model meets the prediction. The method may include sending the selected candidate data driven model to a data driven model optimizer running in the electronic device for tuning a hyper-parameter and the data driven technique running in the data driven model upon determining that the selected candidate data driven model does not meet the prediction.

### CROSS-REFERENCE TO RELATED APPLICATIONS

This application claims priority to IN patent application No. 202341053015 filed on Aug. 7, 2023, the disclosure of which is hereby incorporated by reference herein in its entirety.

### TECHNICAL FIELD

The disclosure relates to the field of data driven methods and/or systems, and for example to methods and/or an electronic device for optimizing training of a data driven model in a wireless network.

### BACKGROUND

Existing methods and systems have developed various capabilities to create and train an open radio access network (ORAN) related machine learning (ML) model and artificial intelligence (AI) model. The ORAN related ML and the ORAN related AI model may be deployed in an O-RAN framework component such as non real time radio intelligent controller (Non RT RIC) and a near real time radio intelligent controller (Near RT RIC). But, the existing methods and systems have encountered a need for optimization of a trained model (e.g., AI model, ML model or the like) to see if the trained model may be optimized/suitable for ever changing reconfigurable network. The existing methods and systems may able to tune the trained model to fit as per a user accuracy and an inference time configuration based on current capabilities of underlying network platform. But, the existing methods and systems do not assist to tune the trained model to fit as per the user accuracy and the inference time configuration based on runtime capabilities of the changing reconfigurable network.

In other words, a deployment of the trained AI model and the ML model at crucial junctions of the network is increasing to make network more intelligent and the other hand a network infrastructure is changing every moment with a arrival of a cloud based network infrastructure. Based on the runtime capabilities of the changing reconfigurable network, the trained AI model and the ML model are not performing well in terms of the inference time and the prediction accuracy (due to changes in the underlying infrastructure and ML resources such as change in compute and GPU/Core resource). The existing methods and systems observed that the inference time of the trained model start varying (at every 1 minutes (ms) for example) as the underlying ML resources varies. Hence, the Near RT RIC expects to finish an ML inference and an AI inference and policy execution within 1 ms (for example). This may lead to non fulfilment of service level agreements (SLAs). This also creates a lot of pain of retraining and redeploying the AI model and ML model in a repeated cycle in a try and error methodology by assuming that the newly retrained model may perform well in a changed target site/environment. This is very time consuming and never ending process.

FIG. 1 and FIG. 2 are example illustrations (100 and 200) in which trained AI/ML model is deployed in a wireless network (e.g., ORAN or the like), according to prior art.

As shown in FIG. 1, at operation 1, the ML Model is trained at a model training platform (102). At operation 2, the ML model is deployed at the RIC (104) while the current infrastructure (106) or the ML resources are available at plenty. At operation 3, the deployed ML model makes live inference within expected time say in 1 ms (for example).

As shown in FIG. 2, at operation 1, there are changes in infrastructure (106) like decrease in graphical processing unit (GPU) ML resources. At operation 2, the method trains the ML model, at the model training platform (102), upon changing in the infrastructure (106). At operation 3, the ML model is deployed at the RIC (104) but now current infrastructure (106) is at reduced availability. At operation 4, now the inference time is increased (15 ms) due to changes in underlying infrastructure like ML resources and will impact the ML use cases such as delay traffic steering decisions etc.

It is desired to address one or more of the above mentioned disadvantages and/or other short comings or at least provide a useful alternative.

### SUMMARY

Methods and/or an electronic device for optimizing training of a data driven model in a wireless network may be provided.

An example embodiment may provide a trained AI model/ML model to analyse and predict the performance another trained model with respect to its inference time and prediction accuracy for a continuous changing target deployment environment in the wireless network.

An example embodiment may retrain and retune the model continuously to match the inference time and prediction accuracy expected at a given deployment site without even deploying the retrained model.

An example embodiment may train the ML model/AI model which may predict the output within a configured time and accuracy in the wireless network.

An example embodiment may determine a ML model prediction time/AI model prediction time without actually deploying in a target network node environment (or target deployment environment).

An example embodiment may create a trained ML model/AI model for the target network node environment.

An example embodiment may repetitively retrain the ML model/AI model to match the configuration prediction time.

An example embodiment may assist the electronic device (e.g., auto-hyper parameter selection system or the like) that trains and generates the ML model/AI model within a given range of prediction time and prediction accuracy.

An example embodiment may deploy and analyze ML model capabilities/AI model capabilities and provide feedback data about the ML model capabilities/AI model capabilities to the electronic device to further predict the specific prediction time for a given target node.

An example embodiment may continuously relearn from the deployed ML model/the deployed AI model and re-deploy an improved version while handling a trade-off between the prediction accuracy and the prediction time.

An example embodiment may build a data set about network resource details with its prediction and accuracy time.

Certain example embodiments may provide methods for optimizing training of a data driven model in a wireless network. The method may include obtaining and selecting, by a data driven model validation controller running in an electronic device, at least one candidate data driven model from a plurality of candidate data driven models. Further, the method may include determining, by the data driven model validation controller, whether the at least one selected candidate data driven model meets a predefined prediction. In an embodiment, the method may include deploying the at least one selected candidate data driven model to at least one target deployment environment upon determining that the at least one selected candidate data driven model meets the predefined prediction. In another embodiment, the method may include sending the at least one selected candidate data driven model to a data driven model optimizer running in the electronic device for tuning at least one hyper-parameter and at least one data driven technique running in the at least one data driven model upon determining that the at least one selected candidate data driven model does not meet the predefined prediction.

In an example embodiment, the predefined prediction is performed by at least one of an expected inference time and a prediction accuracy, where the predefined prediction is set by at least one of a user, an electronic device, and a network device.

In an example embodiment, the method may include receiving, by the data driven model validation controller, a feedback about performance of the at least one deployed candidate data driven model from the at least one target deployment environment. The feedback may include at least one of a detail about the performance, a number of cores, a central processing unit (CPU) frequency, a type of the CPU, a memory, an accuracy and an inference time.

In an example embodiment, the method may include continuously learning, by the data driven model validation controller, a data item from the at least one deployed candidate data driven model from the at least one target deployment environment. Further, the method may include re-deploying, by the data driven model validation controller, an updated version of the at least one deployed candidate data driven model based upon continuously learning the data item.

In an example embodiment, determining, by the data driven model validation controller, whether the at least one candidate data driven model meets the predefined prediction may include analyzing and predicting, by the data driven model validation controller, a performance the at least one candidate data driven model with respect to an inference time and a prediction accuracy for a continuous changing target deployment environment over a period of time, and determining, by the data driven model validation controller, whether the at least one candidate data driven model meets the predefined prediction based on the analyzes and prediction.

In an example embodiment, obtaining, by the data driven model validation controller, the at least one candidate data driven model from the plurality of candidate data driven models may include receiving, by the data driven model validation controller, at least one resource information associated with at least one data driven model and at least one target deployment environment to train and develop at least one candidate data driven model from the plurality of candidate data driven models, and obtaining, by the data driven model validation controller, the at least one candidate data driven model from the plurality of candidate data driven models based on the obtained information.

In an example embodiment, the at least one resource information may include at least one of a target network node ID, a number of core, a CPU frequency, a type of the CPU, and a memory.

In an example embodiment, tuning the at least one hyper-parameter and the at least one data driven technique running in the at least one data driven model may include selecting at least one optimal data driven technique from a plurality of optimal data driven techniques to predict an output within an expected inference time and a prediction accuracy, selecting at least one optimal hyper-parameter from a plurality of hyper-parameters to predict the output within the expected inference time and the prediction accuracy, prioritizing the at least one optimal data driven technique from the plurality of optimal data driven techniques and the at least one optimal hyper-parameter from the plurality of hyper-parameters, and tuning the at least one hyper-parameter and the at least one data driven technique running in the at least one data driven model based on the priority.

In an example embodiment, tuning the at least one hyper-parameter and the at least one data driven technique running in the at least one data driven model is performed without deploying the at least one selected candidate data driven model.

In an example embodiment, tuning the at least one hyper-parameter and the at least one data driven technique running in the at least one data driven model is performed to match an inference time and a prediction accuracy expected at the at least one target deployment environment.

In an example embodiment, the at least one target deployment environment may include at least one of an open centralized unit (O-CU), an open distributed unit (O-DU), a near-real-time RAN intelligent controller (RT RIC), a Non-RT RIC, a server, a cloud, an eNB, and a gNB.

Certain example embodiments may disclose an electronic device including a data driven model validation controller coupled, directly or indirectly, with a processor(s) and a memory. The data driven model validation controller is configured to obtain and select at least one candidate data driven model from a plurality of candidate data driven models. Further, the data driven model validation controller is configured to determine whether the at least one selected candidate data driven model meets a predefined prediction. In an example embodiment, the data driven model validation controller is configured to deploy the at least one selected candidate data driven model to at least one target deployment environment upon determining that the at least one selected candidate data driven model meets the predefined prediction. In another example embodiment, the data driven model validation controller is configured to send the at least one selected candidate data driven model to a data driven model optimizer running in the electronic device for tuning at least one hyper-parameter and at least one data driven technique running in the at least one data driven model upon determining that the at least one selected candidate data driven model does not meet the predefined prediction.

In an example embodiment, the disclosure relates to one or more non-transitory computer-readable storage media storing computer-executable instructions that, when executed by at least one processor of a network node, cause the network node to perform operations. The operations comprises transmit core-load data and a plurality of key indicators of each core group of a plurality of core groups in the multi-core processor to a central management entity (CME); receive a core-load prediction model associated for the each core group from the CME in response to the transmission, the core-lode prediction model being determined based on the core-load data and the plurality of key indicators of the each core group; determine an estimated core-load data for the each core group based on the plurality of key indicators of each core group using the associated core-load prediction model; determine a maximum estimated core-load data among the estimated core-load data of each core group; and determine a multi-core processor frequency for the network node based on the maximum estimated core-load data

The foregoing summary is merely illustrative and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and are a part of this disclosure, illustrate various example embodiments and together with the description, serve to explain the disclosed principles. The same reference numbers may be used throughout the figures to reference like features and components. The above and other aspects, features and advantages of certain embodiments of the disclosure will be more apparent from the following detailed description, taken in conjunction with the accompanying drawings, in which:

FIG. 1 and FIG. 2 are example illustrations in which trained AI/ML model is deployed in a wireless network, according to prior art;

FIG. 3 shows various hardware components of an electronic device, according to an example embodiment as disclosed herein;

FIG. 4 shows various hardware components of a system for optimizing training of a data driven model in a wireless network, according to an example embodiment as disclosed herein;

FIG. 5 is an example illustration in which a server optimizes training of the data driven model in the wireless network, according to an example example embodiment as disclosed herein;

FIG. 6 is an example illustration in which an O-RAN compliant environment optimizes training of the data driven model, according to an example embodiment as disclosed herein;

FIG. 7 is a flow chart illustrating a method for optimizing training of the data driven model in the wireless network, according to an example embodiment as disclosed herein;

FIG. 8 is an example flow chart illustrating a method for optimizing training of the data driven model in the wireless network by detecting the changed infrastructure and available ML/AI resources, according to an example embodiment as disclosed herein; and

FIG. 9 is an example flow chart illustrating a method for optimizing training of the data driven model in the wireless network by detecting the changed infrastructure and available ML/AI resources, according to an example embodiment as disclosed herein.

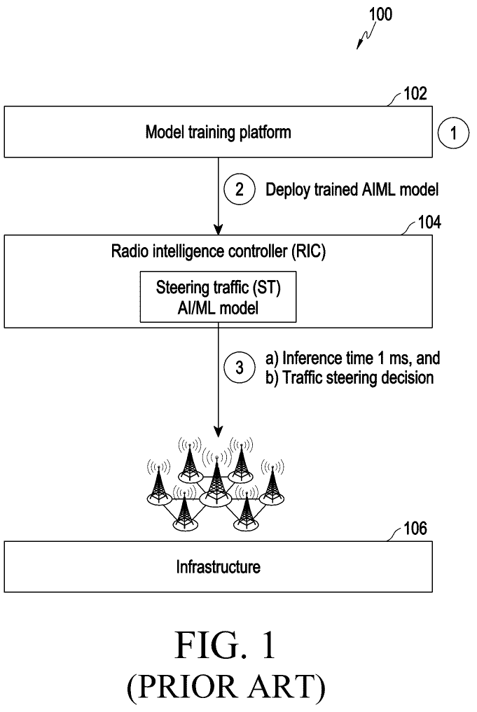

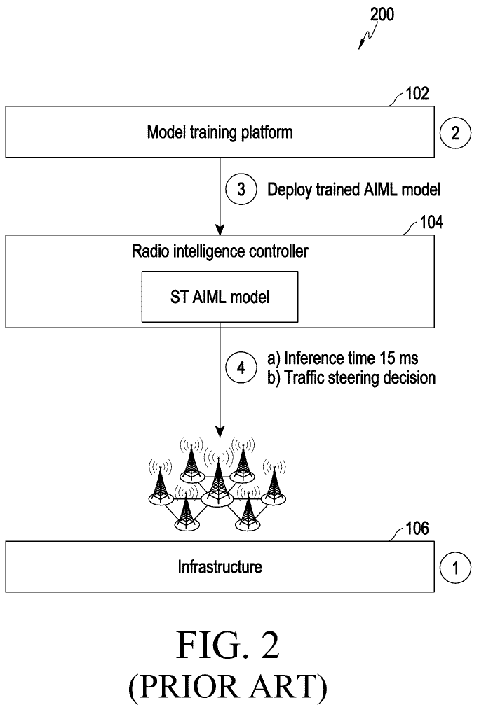

It should be appreciated by those skilled in the art that any block diagrams herein represent conceptual views of illustrative systems embodying the principles of the disclosure. Similarly, it will be appreciated that any flowcharts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

[1] In the disclosure, the word “exemplary” is used herein to refer, for example, to “serving as an example, instance, or illustration.” Any embodiment or implementation of the disclosure described herein as “exemplary” is not necessarily to be construed as preferred or advantageous over other embodiments.
[2] While the disclosure is susceptible to various modifications and alternative forms, various example embodiments are shown by way of example in the drawings and will be described in greater detail below. It should be understood, however that it is not intended to limit the disclosure to the particular forms disclosed, but on the contrary, the disclosure is to cover all modifications, equivalents, and alternatives falling within the scope of the disclosure.
[3] The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

In the following detailed description, reference is made to the accompanying drawings that form a part hereof, and in which are shown by way of illustration various example embodiments in which the disclosure may be practiced. These embodiments are described in sufficient detail to enable those skilled in the art to practice the disclosure, and it is to be understood that various embodiments may be utilized and that changes may be made without departing from the scope of the disclosure. The following description is, therefore, not to be taken in a limiting sense.

Certain example embodiments may achieve methods for optimizing training of a data driven model in a wireless network. The method may include obtaining and selecting, by a data driven model validation controller running in an electronic device, a candidate data driven model from a plurality of candidate data driven models. Further, the method may include determining, by the data driven model validation controller, whether the selected candidate data driven model meets a predefined prediction. In an embodiment, the method may include deploying the selected candidate data driven model to a target deployment environment upon determining that the selected candidate data driven model meets the predefined prediction. In another embodiment, the method may include sending the selected candidate data driven model to a data driven model optimizer running in the electronic device for tuning a hyper-parameter and a data driven technique running in the data driven model upon determining that the selected candidate data driven model does not meet the predefined prediction.

Unlike conventional methods and systems, the proposed method may be used to find the ML/AI model prediction time without actually deploying in a target deployment environment by repeatedly changing the ML techniques/AI techniques and its configuration to meet the user specified prediction time and the prediction accuracy. The proposed method may be used to create the ML model/AI model to analyse and already trained ML model/AI model. The proposed method may be used to provide a desired ML model/AI model as per standards and assists in ML/AI deployment as per the reconfigurable networks.

The method may be used to provide the trained AI model/ML model to analyse and predict the performance another trained model with respect to its inference time and prediction accuracy for the continuous changing target deployment environment in the wireless network. The method may be used to retrain and retune the model continuously to match the inference time and prediction accuracy expected at given deployment site without even deploying the retrained model. The proposed method may be used to reduce an operational expenditure (OPEX) of a network operator and enhance an quality of service (QOS)/quality of experience (QoE) of operator's network by dynamically configuring the ML deployments and judicially utilizing the ML resources. In other words, the ML deployment/AI deployment has to be done dynamically based on reconfigurable networks (e.g., reconfigurable 5G networks or the like).

The proposed method may be used to deploy and analyze the ML model capabilities/AI model capabilities and provide the feedback data about a targeted system to further predict the specific prediction time for a given target node. The proposed method may be used for continuously relearning from the deployed ML model and re-deploying the improved version while handling the trade-off between the prediction accuracy and prediction time.

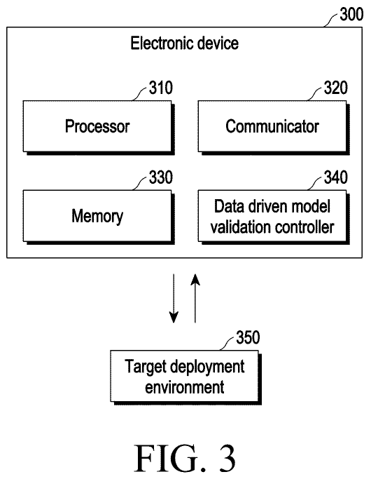

Referring now to the drawings, and more particularly to FIGS. 3 through 9, where similar reference characters denote corresponding features consistently throughout the figures, there are shown example embodiments.

FIG. 3 shows various hardware components of an electronic device (300), according to an embodiment as disclosed herein. The electronic device (300) may be, for example, but not limited to a laptop, a desktop computer, a notebook, a device-to-device (D2D) device, a vehicle to everything (V2X) device, a smartphone, a foldable phone, a smart TV, a tablet, an immersive device, a server, and an internet of things (IoT) device. In an embodiment, the electronic device (300) includes a processor (310), a communicator (320), a memory, and a data driven model validation controller (340). The processor (310), comprising processing circuitry, is communicatively coupled, directly or indirectly, with the communicator (320) comprising communication circuitry, the memory (330), and the data driven model validation controller (340) which may comprise processing circuitry. In an example embodiment, the data driven model validation controller (340) may be configured to be included in the processor (310).

The data driven model validation controller (340) obtains and selects a candidate data driven model from a plurality of candidate data driven models. The data driven models may be, for example, but not limited to a linear regression, a logistic regression, a decision tree, a support vector machine (SVM), naive bayes, a k-nearest neighbor (kNN), K-Means, random forest, dimensionality reduction techniques, and gradient boosting techniques. In an embodiment, the data driven model validation controller (340) receives resource information associated with the data driven model and the target deployment environment (350) to train and develop the candidate data driven model from the plurality of candidate data driven models. The target deployment environment (350) may be, for example, but not limited to an open centralized unit (O-CU), an open distributed unit (O-DU), a near-real-time RAN intelligent controller (RT RIC) (104), a Non-RT RIC, a server, a cloud, an eNB, and a gNB. The resource information may be, for example, but not limited to a target network node identifier (ID), a number of core, a CPU frequency, a type of the CPU, and the memory (330). Based on the obtained information, the data driven model validation controller (340) obtains the candidate data driven model from the plurality of candidate data driven models.

Further, the data driven model validation controller (340) determines whether the selected candidate data driven model meets a predefined prediction. The predefined prediction is determined by an expected inference time and a prediction accuracy. The predefined prediction is set by a user (e.g., network operator or the like), the electronic device (300), and a network device (e.g., eNB, gNB, O-CU, O-DU or the like).

In an embodiment, the data driven model validation controller (340) analyzes and predicts a performance the candidate data driven model with respect to the inference time and the prediction accuracy for a continuous changing target deployment environment (350) over a period of time. Based on the analyzes and prediction, the data driven model validation controller (340) determines the candidate data driven model meets the predefined prediction.

In an embodiment, upon determining that the selected candidate data driven model meets the predefined prediction, the data driven model validation controller (340) deploys the selected candidate data driven model to the target deployment environment (350).

In another embodiment, upon determining that the selected candidate data driven model does not meet the predefined prediction, the data driven model validation controller (340) sends the selected candidate data driven model to a data driven model optimizer (410) running in the electronic device (300) for tuning a hyper-parameter and a data driven technique running in the data driven model. In an example, number of nodes, hidden layer, dropout are few examples hyper parameter for LSTM algorithm.

In an embodiment, the data driven model validation controller (340) selects an optimal data driven technique from the plurality of optimal data driven techniques to predict an output within the expected inference time and the prediction accuracy. Further, the data driven model validation controller (340) selects an optimal hyper-parameter from the plurality of hyper-parameters to predict the output within the expected inference time and the prediction accuracy. Further, the data driven model validation controller (340) prioritizes the optimal data driven technique from the plurality of optimal data driven techniques and the optimal hyper-parameter from the plurality of hyper-parameters. Further, the data driven model validation controller (340) tunes the hyper-parameter and the data driven technique running in the data driven model based on the priority.

In another embodiment, the data driven model validation controller (340) tunes the hyper-parameter and the data driven technique running in the data driven model without deploying the selected candidate data driven model. In another embodiment, the data driven model validation controller (340) tunes the hyper-parameter and the data driven technique running in the data driven model to match the inference time and the prediction accuracy expected at the target deployment environment (350).

Further, the data driven model validation controller (340) receives a feedback about performance of the deployed candidate data driven model from the target deployment environment (350). The feedback may be, for example, but not limited to a detail about the performance, a number of cores, the CPU frequency, the type of the CPU, the memory (330), the accuracy and the inference time.

Further, the data driven model validation controller (340) continuously learns a data item (e.g., performance) from the deployed candidate data driven model from the target deployment environment (350). Based upon continuously learning the data item, the data driven model validation controller (340) re-deploys an updated version of the deployed candidate data driven model.

In an example, the ML model (e.g., validator model) inspects and predicts the inference time for an “actual use case model” (e.g. hand over prediction ML model), once that is done, the target site has only “hand over prediction ML model” to be deployed, the validator application at the target site will only collect the actual performance of tuned “hand over prediction ML model”, so that there will not be any extra load on ML resources due to the data driven model validation controller (340) running at the target site.

In another example, if a traffic steering (TS) xApp in the O-RAN needs to make policy changes in real time, the data driven model validation controller (340) will insure that the trained model of xApp predicts and does the policy changes within the prescribed standard of xApp, (for e.g. within 10 ms).

The data driven model validation controller (340) is physically implemented by analog or digital circuits such as logic gates, integrated circuits, microprocessors, microcontrollers, memory circuits, passive electronic components, active electronic components, optical components, hardwired circuits, or the like, and may optionally be driven by firmware.

Further, the processor (310) is configured to execute instructions stored in the memory (330) and to perform various processes. The communicator (320) is configured for communicating internally between internal hardware components and with external devices via one or more networks. The memory (330) also stores instructions to be executed by the processor (310). The memory (330) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (330) may, in some examples, be considered a non-transitory storage medium. The term “non-transitory” may indicate that the storage medium is not embodied in a carrier wave or a propagated signal. However, the term “non-transitory” should not be interpreted that the memory (330) is non-movable. In certain examples, a non-transitory storage medium may store data that can, over time, change (e.g., in random access memory (RAM) or cache).

Further, at least one of the plurality of modules/controller may be implemented through the AI model using a data driven controller (not shown). The data driven controller may be a ML model based controller and AI model based controller. A function associated with the AI model may be performed through the non-volatile memory, the volatile memory, and the processor (310). The processor (310) may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). Each “module” herein may comprise circuitry.

Each “processor” herein includes processing circuitry, and/or may include multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The one or a plurality of processors control the processing of the input data in accordance with a predefined operating rule or AI model stored in the non-volatile memory and the volatile memory. The predefined operating rule or artificial intelligence model is provided through training or learning.

Here, being provided through learning means that a predefined operating rule or AI model of a desired characteristic is made by applying a learning algorithm to a plurality of learning data. The learning may be performed in a device itself in which AI according to an embodiment is performed, and/o may be implemented through a separate server/system.

The AI model may include of a plurality of neural network layers. Each layer has a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann machine (RBM), deep belief network (DBN), bidirectional recurrent deep neural network (BRDNN), generative adversarial networks (GAN), and deep Q-networks.

The learning algorithm is a method for training a predetermined target device (for example, a robot) using a plurality of learning data to cause, allow, or control the target device to make a determination or prediction. Examples of learning algorithms include, but are not limited to, supervised learning, unsupervised learning, semi-supervised learning, or reinforcement learning.

Although FIG. 3 shows various hardware components of the electronic device (300) but it is to be understood that other embodiments are not limited thereon. In other embodiments, the electronic device (300) may include less or more number of components. Further, the labels or names of the components are used only for illustrative purpose and does not limit the scope of the disclosure. One or more components may be combined together to perform same or substantially similar function in the electronic device (300).

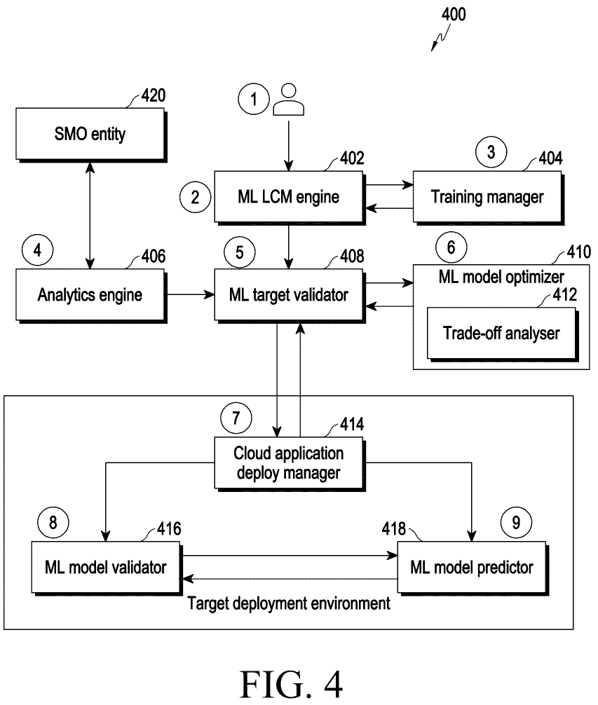

FIG. 4 shows various hardware components of a system (400) for optimizing training of the data driven model in the wireless network, according to an embodiment as disclosed herein. The wireless network may be, for example, but not limited to a fourth generation (4G) network, a fifth generation (5G) network, a sixth generation (6G) network, the ORAN or the like.

In an embodiment, the system (400) includes a ML life cycle management (LCM) engine (402), a training manager (404), an analytics engine (406), a ML target validator (408), a ML model optimizer (410) (or data driven model optimizer), a trade-off analyser (412), a cloud application deploy manager (414), a ML model validator (416), a ML model predictor (418), and a SMO entity (420).

The ML LCM engine (402) is communicated with the training manager (404) and the ML target validator (408). The analytics engine (406) is communicated with the SMO entity (420) and the ML target validator (408). The ML target validator (408) is communicated with the ML model optimizer (410). The trade-off analyser (412) is included in the ML model optimizer (410). Also, the ML target validator (408) is communicated with the cloud application deploy manager (414). The cloud application deploy manager (414) is communicated with the ML model validator (416) and the ML model predictor (418).

As shown in FIG. 4, at operation 1, the network operator creates the use cases (e.g., congestion prediction use case, handover use case, a cell selection use case, a cell reselection use case or the like) and defines the ML related parameters, the threshold, the target environments etc. At operation 2, the ML LCM engine (402) is an training initiator platform. The ML LCM engine (402) may be, for example, but not limited to a TensorFlow, Keras or the like. The ML LCM engine (402) receives the request from the network operator and initiates the ML training.

At operation 3, the training manager (404) such as kubeflow (404) trains the ML model (e.g., congestion prediction ML Model (CPM)) for deployment using the supplied training data. At operation 4, the ML target validator (408) fetches the target deployment node's resources details such as ML resources, compute resource etc. via the analytics engine (404). The analytics engine (404) connects to an element management system (EMS) and does initial prediction if the currently trained model (CPM) may perform the prediction as per user description in the selected target node. The EMS manages the network entity and have full access to details of underlying infrastructure (106) and resources.

The analytics engine (406) is physically implemented by analog or digital circuits such as logic gates, integrated circuits, microprocessors, microcontrollers, memory circuits, passive electronic components, active electronic components, optical components, hardwired circuits, or the like, and may optionally be driven by firmware.

At operation 5, if currently trained ML cannot satisfy the user requirement such as prediction accuracy and inference time, the requirement will be sent to the ML model optimizer (410) to tune the hyper-parameters and different ML techniques. The tuned model must be within required prediction accuracy. If the trade-off is not possible, the ML model optimizer (410) notifies to the ML LCM engine (402).

At operation 6, the ML model optimize (410) returns the tuned model and ready for deployment at target environment. At operation 7, the ML target validator (408) deploys two applications at target environment via the cloud application deployment manager (414) (e.g., Kubernetes, openstack, or the like). The tuned ML model and a feedback application (e.g., ML model validator (416)) further collects performance of deploy ML model. The performance is related to details of number of cores, details of CPU frequency, the details of CPU type, the performance of the memory (330), performance of the accuracy and prediction/inference time.

At operation 8 and operation 9, the feedback from the ML model validator (416) is further used to build the data set for prediction based on underlying resources, the ML Model techniques and its hyper-parameters. The ML model predictor (418) may predict the inference time. “Based on” as used herein covers based at least on.

In other words, the ML model validator (416) is deployed along with tuned ML model (e.g. CPM Model) to check if the tuned model is actually performing as expected, the feedback data helps in building ML model more accurate.

The ML target validator (408) is physically implemented by analog or digital circuits such as logic gates, integrated circuits, microprocessors, microcontrollers, memory circuits, passive electronic components, active electronic components, optical components, hardwired circuits, or the like, and may optionally be driven by firmware.

The ML model optimizer (410) is physically implemented by analog or digital circuits such as logic gates, integrated circuits, microprocessors, microcontrollers, memory circuits, passive electronic components, active electronic components, optical components, hardwired circuits, or the like, and may optionally be driven by firmware.

The ML model validator (416) is physically implemented by analog or digital circuits such as logic gates, integrated circuits, microprocessors, microcontrollers, memory circuits, passive electronic components, active electronic components, optical components, hardwired circuits, or the like, and may optionally be driven by firmware.

The ML model predictor (418) is physically implemented by analog or digital circuits such as logic gates, integrated circuits, microprocessors, microcontrollers, memory circuits, passive electronic components, active electronic components, optical components, hardwired circuits, or the like, and may optionally be driven by firmware.

The trade-off analyser (412) selects the best ML techniques along with its best hyper parameters values, to train the ML model, so that the trade-off analyser (412) always predict the output within the configured time and accuracy. In an example, the hyper parameters value of any ML techniques are properties of ML model whose value may be changes to make the performance of the model better. In an example, number of nodes, hidden layer, dropout are few examples hyper parameter for LSTM algorithm. Further, the trade-off analyser (412) maintains the state of all previous iteration of trained and deployed model. Further, the trade-off analyser (412) iteratively allocates incentive points to each attributes of ML model. Further, the trade-off analyser (412) priorities one of main configuration like predicting an output within certain time. In an example, the hyper-parameter which helps in increasing the model performance and decreasing the inference time are added to a list/map in order of their collective benefit/gain based on the allocated incentive points. For example, a list number of layers 3→gain 90%, Epochs→20→95% gain, Epochs→23→96% gain, and Epochs→25→No Gain. Further, the trade-off analyser (412) may demerit few hyper parameters or reduce accuracy to meet the trade-off.

In other words, the trade-off analyser (412) checks and decides, if the required prediction accuracy and inference time may be achieved by various combinations of ML techniques\and its hyper-parameters. The trade-off analyser (412) selects various related ML techniques from a repository (not shown).

The trade-off analyser (412) is physically implemented by analog or digital circuits such as logic gates, integrated circuits, microprocessors, microcontrollers, memory circuits, passive electronic components, active electronic components, optical components, hardwired circuits, or the like, and may optionally be driven by firmware.

In an embodiment, the various hardware components of the system (400) is implemented in the data driven model validation controller (340). In another embodiment, the various hardware components of the system (400) is placed outside the data driven model validation controller (340) to assist various operation to optimize training of the data driven model in the wireless network.

Although FIG. 4 shows various hardware components of the system (400) but it is to be understood that other embodiments are not limited thereon. In other embodiments, the system (400) may include less or more number of components. Further, the labels or names of the components are used only for illustrative purpose and does not limit the scope of the invention. One or more components may be combined together to perform same or substantially similar function in the system (400).

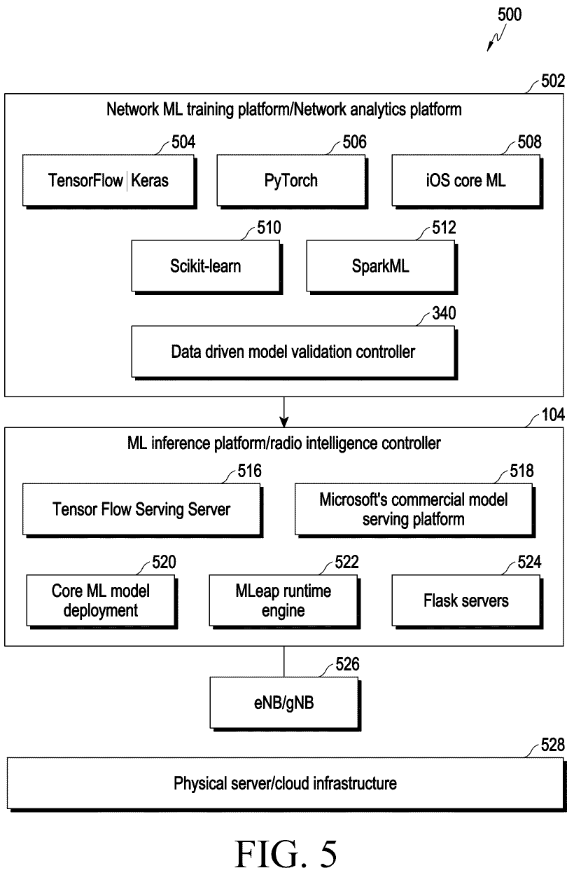

FIG. 5 is an example illustration in which a server (500) optimizes training of the data driven model in the wireless network, according to an embodiment as disclosed herein. In an embodiment, the server (500) includes the ML inference platform/the radio intelligence controller (104) that is communicated with the network ML training platform/network analytics platform (502), the eNB/gNB (526) and the physical server/cloud infrastructure (528).

A TensorFlow/Keras (504), a PyTorch (506), an iOS core ML (508), a scikit-Learn (510, a SparkML (512), and the data driven model validation controller (340) are included in the network ML training platform/Network analytics platform (502). A tensorFlowServing Server (516), a Microsoft's commercial model serving platform (518), a Core ML Model deployment (520), a MLeap runtime engine (522), and flask servers (524) are included in the ML inference platform/radio intelligence controller (104). Based on the proposed method, the data driven model validation controller (340) is deployed and operated in platforms (e.g., TensorFlow/Keras (504), the PyTorch (506), the iOS core ML (508), the scikit-Learn (510), the SparkML (512), the tensorFlowServing server (516), the Microsoft's commercial model serving platform (518), the core ML model deployment (520), the MLeap runtime engine (522), and flask servers (524)). The operators supported by the platforms are a deploy model, a get model and an inference prediction model.

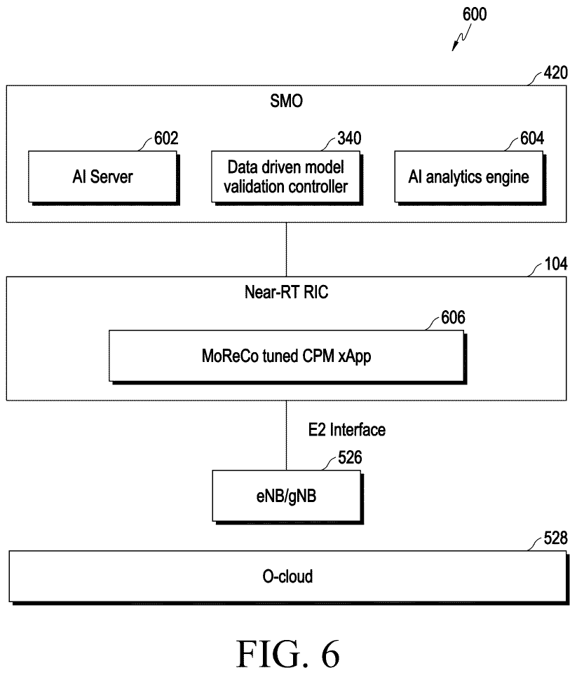

FIG. 6 is an example illustration in which an O-RAN compliant environment (600) optimizes training of the data driven model, according to an embodiment as disclosed herein. Based on the proposed methods, the data driven model validation controller (340) (e.g., MoReCo or the like) may be part of the service management and orchestration (SMO) entity (420) in O-RAN based products.

The O-RAN compliant environment (600) includes the SMO entity (420), the near-RT RIC (104), the eNB/gNB (526) and the O-cloud (528). The near-RT RIC (104) is communicated with the SMO entity (420), the eNB/gNB (526) and the O-cloud (528). An AI server (602), the data driven model validation controller (340), and an AI analytics engine (604) are included in the SMO entity (420). A MoReCo tuned CPM xApp (606) is included in the Near-RT RIC (104). The AI analytics engine (604) interacts with underlying designated target environment, where the data driven model validation controller (340) is operated. An operation of the AI analytics engine (604) are obtaining the target environment resources, the detailed OS version, and details available CPU.

In an example, the ML model (e.g., validator model) inspects and predicts the inference time for “Actual use case Model” (e.g. Hand Over Prediction” ML Model), once that is done, the target site has only “Hand over prediction ML Model” to be deployed, the validator application at target site will only collect the actual performance of tuned “Hand over prediction ML Model”, So there will not be any extra load on ML resources due to “MoReco” at target site.

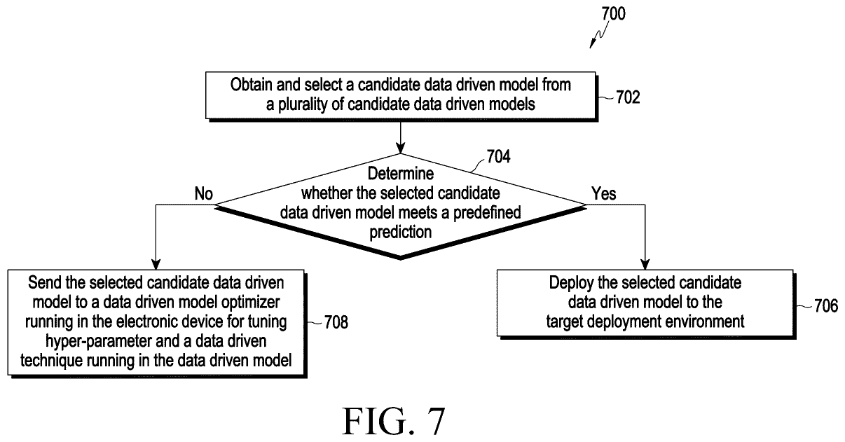

FIG. 7 is a flow chart (700) illustrating a method for optimizing training of the data driven model in the wireless network, according to an embodiment as disclosed herein. The operations (702-708) are handled by the data driven model validation controller (340).

At operation 702, the method includes obtaining and selecting the candidate data driven model from the plurality of candidate data driven models. At operation 704, the method includes determining whether the selected candidate data driven model meets the predefined prediction. In an embodiment, at operation 706, the method includes deploying the selected candidate data driven model to the target deployment environment (350) upon determining that the selected candidate data driven model meets the predefined prediction. In another embodiment, at operation 708, the method includes sending the selected candidate data driven model to the data driven model optimizer (410) running in the electronic device (300) for tuning the hyper-parameter and the data driven technique running in the data driven model upon determining that the selected candidate data driven model does not meet the predefined prediction.

The proposed method repetitively retrains the ML model to match the configuration prediction time. The proposed method deploys and analyses the ML model capabilities and provides feedback data about the targeted system to further predict the specific prediction time for a given target node. The proposed method continuously relearning from the deployed ML model and re-deploying the improved version while handling the trade-off between the prediction accuracy and prediction time.

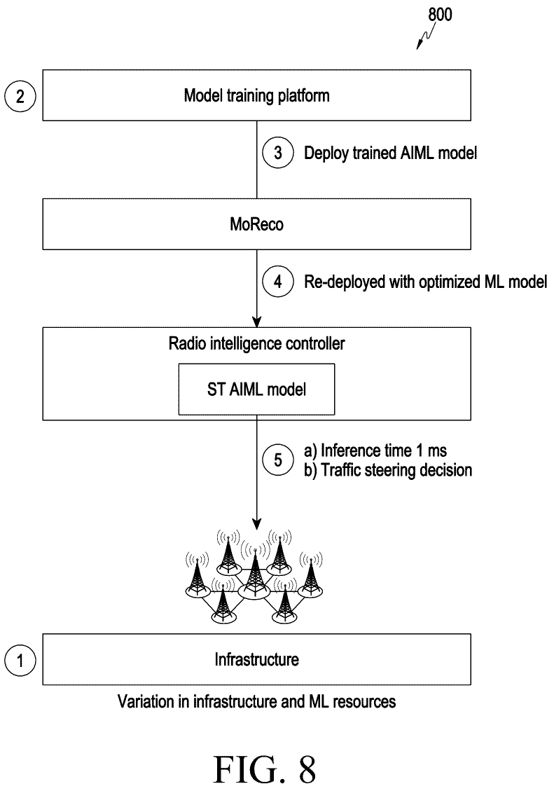

FIG. 8 is an example flow chart (800) illustrating a method for optimizing training of the data driven model in the wireless network by detecting the changed infrastructure and available ML/AI resources, according to an embodiment as disclosed herein.

At operation 1, there are changes in infrastructure like decrease in the GPU ML resources (for example). At operation 2, the model training platform (102) trains the ML model/AI model. At operation 3 and at operation 4, the data driven model validation controller (340) will detect the changed infrastructure and available ML resources/AI resources. The data driven model validation controller (340) will tune the ML model/AI model to make the inference within the user expected inference time and prediction accuracy. The data driven model validation controller (340) shall do trade off if required between prediction accuracy and the inference time. The data driven model validation controller (340) shall retrain the ML model/AI model ready for a specific target deployment. At operation 5, the inference time will be as expected at the given deployment location and ML use cases such as Traffic steering may make decision as expected.

Based on the proposed method, the trained model is going to make the inference at the target deployment system within the expected time. The proposed method retrains the ML model to perform and predict within user specified inference time. The proposed method adapts and tunes the ML model according to dynamic change in network and underlying ML resources automatically. The proposed method predict the inference time of an already trained model without even deploying it on the target system.

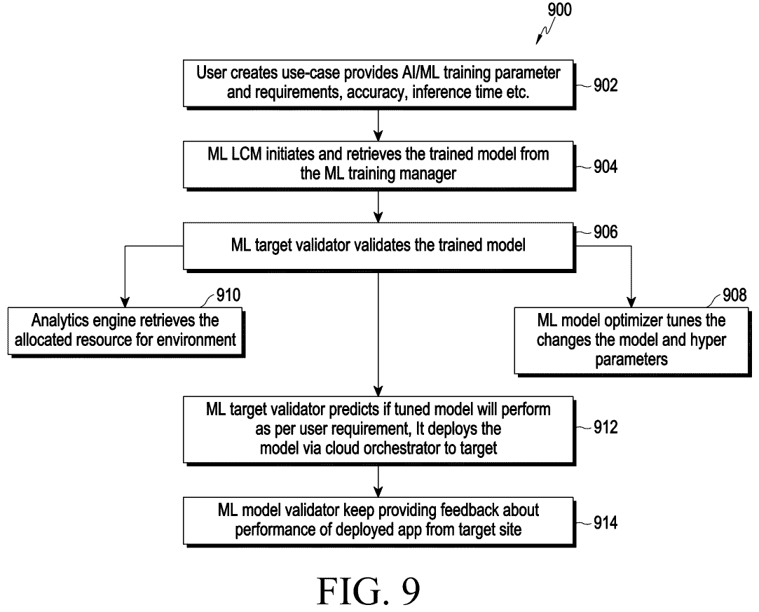

FIG. 9 is an example flow chart (900) illustrating a method for optimizing training of the data driven model in the wireless network by detecting the changed infrastructure and available ML/AI resources, according to an embodiment as disclosed herein.

At operation 902, the user of the electronic device (300) creates the use case and provides the AI/ML training parameter and requirements, accuracy, inference time etc. At operation 904, the ML LCM engine (402) initiates and retrieves the trained model from the ML training manager (404). At operation 906, the ML target validator (408) validates the trained model. At operation 908, the ML model optimizer (410) tunes the changes the model and hyper parameters. At operation 910, the analytics engine (406) retrieves the allocated resource for the environment. At operation 912, the ML target validator (408) predicts if the tuned model will perform as per user requirement. The ML target validator (408) deploys the model via a cloud orchestrator to the target site. At operation 914, the ML model validator (416) keeps providing feedback about performance of the deployed application from the target site.

Each embodiment herein may be used in combination with any other embodiment(s) described herein.

The various actions, acts, blocks, steps, operations, or the like in the flow charts (700-900) may be performed in the order presented, in a different order or simultaneously. Further, in some embodiments, some of the actions, acts, blocks, steps, operations, or the like may be omitted, added, modified, skipped, or the like without departing from the scope.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments, those skilled in the art will recognize that the embodiments herein may be practiced with modification within the spirit and scope of the embodiments as described herein.

What is claimed is:

1. A method for training of a data driven model by an electronic device in a wireless network, the method comprising:
obtaining at least one candidate data driven model from a plurality of candidate data driven models;
determining whether the at least one candidate data driven model meets a predefined prediction;
deploying the at least one candidate data driven model to at least one target deployment environment upon determining that the at least one candidate data driven model meets the predefined prediction; and
tuning at least one hyper-parameter and at least one data driven technique upon determining that the at least one candidate data driven model does not meet the predefined prediction.

2. The method of claim 1, wherein the predefined prediction is performed by at least one of an expected inference time and a prediction accuracy, wherein the predefined prediction is set by at least one of a user, an electronic device, and a network device.

3. The method of claim 1, further comprising:
receiving a feedback about performance of the at least one deployed candidate data driven model from the at least one target deployment environment, wherein the feedback comprises at least one of a detail about the performance, a number of cores, a central processing unit (CPU) frequency, a type of the CPU, a memory, an accuracy and an inference time.

4. The method of claim 1, further comprising:
continuously learning a data item from the at least one deployed candidate data driven model from the at least one target deployment environment; and
re-deploying an updated version of the at least one deployed candidate data driven model based upon continuously learning the data item.

5. The method of claim 1, wherein determining whether the at least one candidate data driven model meets the predefined prediction comprises:
analyzing and predicting a performance the at least one candidate data driven model with respect to an inference time and a prediction accuracy for a continuous changing target deployment environment over a period of time; and
determining whether the at least one candidate data driven model meets the predefined prediction based on the analyzes and prediction.

6. The method of claim 1, wherein obtaining the at least one candidate data driven model from the plurality of candidate data driven models comprises:
receiving at least one resource information associated with at least one data driven model and at least one target deployment environment to train and develop at least one candidate data driven model from the plurality of candidate data driven models; and
obtaining the at least one candidate data driven model from the plurality of candidate data driven models based on the obtained information.

7. The method of claim 6, wherein the at least one resource information comprises at least one of a target network node identifier (ID), a number of core, a central processing unit (CPU) frequency, a type of the CPU, and a memory.

8. The method of claim 1, wherein tuning the at least one hyper-parameter and the at least one data driven technique running in the at least one data driven model comprises:
selecting at least one data driven technique from a plurality of data driven techniques to predict an output within an expected inference time and a prediction accuracy;
selecting at least one hyper-parameter from a plurality of hyper-parameters to predict the output within the expected inference time and the prediction accuracy;
prioritizing the at least one data driven technique from the plurality of data driven techniques and the at least one hyper-parameter from the plurality of hyper-parameters; and
tuning the at least one hyper-parameter and the at least one data driven technique running in the at least one data driven model based on the priority.

9. The method of claim 1, wherein tuning the at least one hyper-parameter and the at least one data driven technique running in the at least one data driven model is performed without deploying the at least one candidate data driven model.

10. The method of claim 1, wherein tuning the at least one hyper-parameter and the at least one data driven technique running in the at least one data driven model is performed to match an inference time and a prediction accuracy expected at the at least one target deployment environment.

11. The method of claim 1, wherein the at least one target deployment environment comprises at least one of an open centralized unit (O-CU), an open distributed unit (O-DU), a near-real-time radio access network (RAN) intelligent controller (RT RIC) (104), a non-RT RIC, a server, a cloud, an eNB, and a gNB.

12. An electronic device, comprising:
at least one processor comprising processing circuitry; and
a memory communicatively coupled to at least one processor, wherein the memory stores one or more computer programs including processor-executable instructions, and the at least one processor, individually and/or collectively, is configured to:
obtain at least one candidate data driven model from a plurality of candidate data driven models;
determine whether the at least one candidate data driven model meets a predefined prediction;
deploy the at least one candidate data driven model to at least one target deployment environment upon determining that the at least one candidate data driven model meets the predefined prediction; and
tuning at least one hyper-parameter and at least one data driven technique upon determining that the at least one candidate data driven model does not meet the predefined prediction.

13. The electronic device of claim 12, wherein the predefined prediction is determined by at least one of an expected inference time and a prediction accuracy, wherein the predefined prediction is set by at least one of a user, an electronic device, and a network device.

14. The electronic device of claim 12, wherein the one or more computer programs further comprise computer-executable instructions that, when executed by the at least one processor, cause the electronic device to:
receive a feedback about performance of the at least one deployed candidate data driven model from the at least one target deployment environment, wherein the feedback comprises at least one of a detail about the performance, a number of cores, a central processing unit (CPU) frequency, a type of the CPU, the memory, an accuracy and an inference time.

15. The electronic device of claim 12, wherein the one or more computer programs further comprise computer-executable instructions that, when executed by the at least one processor, cause the electronic device to:
continuously learn a data item from the at least one deployed candidate data driven model from the at least one target deployment environment; and
re-deploy an updated version of the at least one deployed candidate data driven model based upon continuously learning the data item.

16. The electronic device as claimed in claim 12, wherein thethe one or more computer programs further comprise computer-executable instructions that, when executed by the at least one processor, cause the electronic device to determine whether the at least one candidate data driven model meets the predefined prediction by:
analyzing and predicting a performance the at least one candidate data driven model with respect to an inference time and a prediction accuracy for a continuous changing target deployment environment over a period of time; and
determining the at least one candidate data driven model meets the predefined prediction based on the analyzes and prediction.

17. The electronic device of claim 12, wherein the one or more computer programs further comprise computer-executable instructions that, when executed by the at least one processor, cause the electronic device to obtain the at least one candidate data driven model from the plurality of candidate data driven models by:
receiving at least one resource information associated with at least one data driven model and at least one target deployment environment to train and develop at least one candidate data driven model from the plurality of candidate data driven models; and
obtaining the at least one candidate data driven model from the plurality of candidate data driven models based on the obtained information, wherein the at least one resource information comprises at least one of a target network node identifier (ID), a number of core, a CPU frequency, a type of the CPU, and the memory.

18. The electronic device of claim 12, wherein the one or more computer programs further comprise computer-executable instructions that, when executed by the at least one processor, cause the electronic device to tune the at least one hyper-parameter and the at least one data driven technique running in the at least one data driven model by:
selecting at least one data driven technique from a plurality of data driven techniques to predict an output within an expected inference time and a prediction accuracy;
selecting at least one hyper-parameter from a plurality of hyper-parameters to predict the output within the expected inference time and the prediction accuracy;
prioritizing the at least one data driven technique from the plurality of data driven techniques and the at least one hyper-parameter from the plurality of hyper-parameters; and
tuning the at least one hyper-parameter and the at least one data driven technique running in the at least one data driven model based on the priority.

19. The electronic device as claimed in claim 12, wherein the one or more computer programs further comprise computer-executable instructions that, when executed by the at least one processor, cause the electronic device to:
tune the at least one hyper-parameter and the at least one data driven technique running in the at least one data driven model without deploying the at least one selected candidate data driven model, or
tune the at least one hyper-parameter and the at least one data driven technique running in the at least one data driven model to match an inference time and a prediction accuracy expected at the at least one target deployment environment (350).

20. One or more non-transitory computer readable storage media storing computer-executable instructions that, when executed by at least one processor of an electronic device, causes the electronic device to perform operations, the operations comprising:
obtain at least one candidate data driven model from a plurality of candidate data driven models;
determine whether the at least one candidate data driven model meets a predefined prediction;
deploy the at least one candidate data driven model to at least one target deployment environment upon determining that the at least one selected candidate data driven model meets the predefined prediction; and
tuning at least one hyper-parameter and at least one data driven technique running in the at least one data driven model upon determining that the at least one candidate data driven model does not meet the predefined prediction.
